(19) United States
(12) Patent Application Publication
(10) Pub. No.: US 2024/0317270 A1
(43) Pub. Date: Sep. 26, 2024

(54) METHOD AND COMPENSATING APPARATUS FOR A VEHICLE FOR COMPENSATING FOR A MANIFESTING DIMINISHED PERFORMANCE OF A COMPUTING DEVICE OF THE VEHICLE

(71) Applicant: Volkswagen Aktiengesellschaft, Wolfsburg (DE)

(72) Inventors: Malte Lutz, Braunschweig (DE); Nicolai Behmann, Hannover (DE)

(21) Appl. No.: 18/611,991

(22) Filed: Mar. 21, 2024

(30) Foreign Application Priority Data
Mar. 21, 2023 (DE) 10 2023 202 522.1

(51) Int. Cl. B60W 60/00; B60W 50/02; B60W 50/029

(52) U.S. Cl. CPC B60W 60/00186; B60W 50/0205; B60W 50/029; B60W 2556/00

(57) ABSTRACT

A method for compensating for a manifesting diminished performance of a computing device of a vehicle that executes vehicle functions. A computing unit takes sensor data for determining a control variable for executing the vehicle function, such as a driving function of the vehicle. In the method, the functional capability of the computing device is monitored to detect a manifesting diminished performance and, when diminished performance is detected, to determine a performance variable that is characteristic of a still available functional capability of the computing device and determining an error variable that is characteristic of an error type relating to the diminished performance of the computing device. When the performance of the vehicle function task is at risk, a compensation function for substitutive execution is determined based on the performance variable or error variable and based on the vehicle function task to be performed.

### CROSS-REFERENCE TO RELATED APPLICATION

This application claims the priority, under 35 U.S.C. § 119, of German Patent Application DE 10 2023 202 522.1, filed Mar. 21, 2023; the prior application is herewith incorporated by reference in its entirety.

### FIELD AND BACKGROUND OF THE INVENTION

The present invention relates to a method and a compensating apparatus for a vehicle for compensating for a manifesting diminished performance of a, in particular central, computing device of a vehicle, which computing device can be used and/or is used to at least partially automatically and preferably fully automatically execute an arising vehicle function for performing a vehicle function task.

So-called “self-driving systems” (SDSs) are typically distinguished by redundant central computing units. According to the prior art, a powerful main computer is frequently complemented by a “simpler” backup unit. While the main computer is predominantly responsible for carrying out the driving task, the backup unit continuously monitors the main computer and often provides only restricted functionalities in the event of an error (e.g., safe stop in the lane in which the vehicle is travelling). However, it is also conceivable for the backup unit to be able to reproduce the full scope of functions of the main computer and to be correspondingly more powerful.

The greatest shortcoming of this concept is that when the main computing unit is functioning normally the backup computer is for the most part unused and/or is used far below its technical capability levels. This means that both installation space and resources in the physical sense are wasted and available computing capacity is not or only rarely fully utilized for large parts of the service life.

United States published patent application US 2021/0331700 A1 discloses a system and a method for determining a risk distribution on the basis of detection zones covered by a multiplicity of sensors of an autonomous vehicle. One embodiment therein is used to disclose a safety redundancy system for autonomous driving (ADS, abbreviation for Autonomous Driving System). The system can adapt a predefined system capability of a performance-oriented primary autonomous driving system (ABS) for dynamic driving tasks and has a safety-based backup ADS as a fallback option. The system can be used to show how sensor system risks can be determined from a mean time between failures.

United States published patent application US 2021/0107499 A1 discloses a method for verifying features for autonomous driving. In particular, the document relates to advanced driver assistance systems. It proposes determining a present ODD (abbreviation for Operational Design Domain). An ODD is understood therein to mean an operating range in which the autonomous driving system is designed to be able to function therein, comprising for example geographical restrictions, road boundaries, environmental boundaries. It also proposes checking whether the vehicle is in an ODD with which a first and a second driver assistance module are compatible. Control of the vehicle platform can be split between the first driver assistance module and the second driver assistance module in this case, for example.

United States published patent application US 2021/0284200 A1 discloses a method for determining a capability limit and an associated risk for a safety-redundant autonomous system in real time. It proposes a primary autonomous driving system, which is responsible for normal autonomous driving, and a backup or secondary autonomous driving system for taking over control of the autonomously driving vehicle if it is established that the primary autonomous driving system is not functioning correctly. The secondary autonomous driving system can plan a backup trajectory in order to take the vehicle to a position of safety if it is established that the primary autonomous driving system is not functioning correctly.

Published international patent application WO 2022/061807 A1 discloses a data storage method and a device therefor. It proposes two nodes, a main node and a backup node, the second node being able to replace the first node, with the result that the availability of the data storage system can be ensured.

### SUMMARY OF THE INVENTION

The present invention is based on the object of overcoming the disadvantages known from the prior art and of providing a method and a compensating apparatus for compensating for a manifesting diminished performance of a, in particular central, computing device of a vehicle that, even in the event of an error, provides the greatest possible scope of driving functions given equally high driving safety.

With the above and other objects in view there is provided, in accordance with the invention, a method for compensating for a diminished performance of a computing device of a vehicle, wherein the computing device is used to automatically execute a vehicle function for performing a vehicle function task and the computing device includes at least one computing unit and is configured for data processing of sensor data acquired by a multiplicity of sensor devices of the vehicle and for taking the sensor data as a basis for determining at least one control variable for executing the vehicle function, the method comprising:
monitoring a functional capability of the computing device in order to detect a manifesting diminished performance of the computing device and, when a manifesting diminished performance is detected, determining at least one performance variable that is characteristic of a still-available functional capability of the computing device and determining at least one error variable that is characteristic of an error type relating to the diminished performance of the computing device;
when a performance of the vehicle function task is at risk, determining at least one compensation function for substitutive execution instead of the vehicle function on a basis of the at least one determined performance variable and/or the at least one error variable and on a basis of the vehicle function task to be performed.

In preferred embodiments, the computing device is a central computing device of the vehicle configured to fully automatically or partially automatically execute the arising vehicle function; the at least one computing unit is a plurality of computing units; and the mentioned vehicle function is a driving function.

For a method according to the invention for compensating for a manifesting diminished performance of a, in particular central, computing device of a vehicle, which computing device can be used and/or is used to at least partially automatically and preferably fully automatically execute an arising vehicle function for performing a vehicle function task, the, in particular central, computing device comprises at least one computing unit and preferably a multiplicity of computing units.

It is conceivable for there to be provision for at least two and preferably precisely two (central) computing units. The computing device is preferably provided as just one component. The two computing units may have a substantially equal/identical functional capability.

Preferably, the (particularly preferably all of the) computing units of the multiplicity of computing units are connected (with high bandwidth, preferably at least 10 Gbit/s) to one another via a communication device for the purpose of data interchange.

Preferably, the computing units (particularly preferably use the communication device to) interchange the respective state of the computing unit with one another. The respective state may be characteristic of an instantaneous functional capability and in particular a diminished performance that has manifested itself. It is also conceivable for the state interchanged in each case to be characteristic of an instantaneous utilization level of the respective computing unit. This affords the advantage that a (substantially) uniform utilization level of all of the computing units of the multiplicity of computing units of the, in particular central, computing device can be attained.

The diminished performance may be a reduced functional capability compared with a functional capability during normal operation. In addition, it may also be a failure of (at least) one computing unit of the (central) computing device.

Preferably, the computing unit is, and particularly preferably, the multiplicity of computing units are (single or multiple) physical control units, (single or multiple) physical chips within a control unit and/or single processors or chiplets within a chip.

The multiplicity of computing units may be installed in the vehicle as by and large one (integral) element. However, it is also conceivable for the computing units to be installed apart from one another in different regions of the vehicle. By way of example, it would be conceivable for at least one computing unit of the computing device to be arranged in a front region of the vehicle, while at least one computing unit of the computing device is arranged in a rear region of the vehicle. This affords the advantage that, for instance in the event of only local damage to the vehicle as a result of an accident, the risk of damage to the entire multiplicity of computing units is reduced. The spacing of the respective computing units advantageously allows a kind of mechanical protection to be attained.

However, preference is given to the (preferably all of the) computing units of the multiplicity of computing units of the computing devices being arranged as close to one another as possible. Advantageously, this allows a latency (time) resulting from a data interchange between the computing units to be reduced as far as possible.

Preferably, the computing device is suitable and intended for data processing of sensor data determined by means of a multiplicity of sensor devices of the vehicle. Preferably, at least one and preferably multiple sensor devices of the vehicle are sensor devices for detecting the vehicle surroundings. The acquisition or determination of the sensor data and/or the data processing is (are) preferably carried out in real time. The sensor devices of the vehicle acquire raw sensor data that are transmitted as sensor data for data processing to the (in particular central) computing device either in unprocessed form or in preprocessed form.

The (in particular central) computing device is suitable and intended for taking the sensor data as a basis for determining at least one control variable for, at least partially automatically and preferably fully automatically, executing the vehicle function, in particular driving function, of the vehicle.

Preferably, the performable determination of the control variable and/or performable data processing of the sensor data for the (respective) arising vehicle function can be carried out by means of a (single) computing unit. However, it is also conceivable for the performable data processing of the sensor data and/or determination of the control variable to be carried out such that (across all of the computing units of the computing device) the (computational) utilization level of all of the computing units is as evenly distributed as possible.

Preferably, the vehicle function is a vehicle function that is executed within an autonomous driving system (self-driving system) of the vehicle. For example, the driving function may be a longitudinal and/or lateral guidance of the vehicle (along a predefined and/or determined trajectory). The vehicle function may also be a trajectory determination that is preferably provided and/or used for (at least partially and preferably fully automatic) vehicle guidance along the determined trajectory.

The method according to the invention comprises monitoring a functional capability of the computing device in order to detect a manifesting diminished performance of the computing device. Preferably, the monitoring is performed by a (in particular processor-based) monitoring unit. By way of example, the monitoring can be carried out by monitoring functions that are provided as standard in (specific) chips.

The method according to the invention comprises, in the event of a manifesting diminished performance (for example of a computing unit of the computing device), determining at least one performance variable that is characteristic of a still available functional capability of the computing device, and preferably determining at least one error variable that is characteristic of an error type relating to, in particular bringing about and/or causing and/or influencing, the diminished performance of the computing device.

Preferably, at least one performance variable and/or error variable is determined for each computing unit of the computing device for which a diminished performance manifests itself.

Furthermore, the method according to the invention comprises, if performance of the vehicle function task is at risk, determining at least one compensation function, preferably for substitutive execution instead of the vehicle function, on the basis of the at least one determined performance variable and/or the at least one error variable and on the basis of the vehicle function task that is to be performed.

In other words, a manifesting diminished performance of at least one computing unit of the computing device results in the still available resources (of possible computing power) being determined and these and also the nature of the error type that leads to the diminished performance being taken as a basis for designing a compensation method that, in consideration of the available resources, can lead to the (original) arising vehicle function task being accomplished or that gets as close to one as possible.

If the vehicle function is, for example, a driving function in which the vehicle is supposed to be taken along a predefined (for instance determined) trajectory to a predefined destination, then (in the event of an error) detected diminished performance can result in it being determined whether the vehicle function can also be executed by means of the still available resources (on the basis of the determined performance variables) while still maintaining (in particular guaranteeing and/or ensuring) vehicle safety.

If adequate vehicle safety can no longer be maintained, a compensation function is preferably determined that reaches the predefined destination (or is suitable and intended therefor) in consideration of the still available (restricted) resources, or functional capability, of the computing device (on the basis of the determined performance variable(s)). It is conceivable for a compensation trajectory to be determined (in particular by the computing device), which differs from the trajectory determined for executing the vehicle function and which is determined in such a way that taking the vehicle along this compensation trajectory requires a reduced functional capability, or computing capacity, of the computing device. In particular, the compensation trajectory is chosen on the basis of the determined performance variable(s) in such a way that the still remaining (diminished) functional capability of the computing device is adequate for carrying out the driving task (here taking the vehicle along the compensation trajectory).

It is also conceivable for a substitute destination to be determined and/or predefined instead of the predefined destination. As such, the substitute destination could be a new destination such as a workshop and/or a service hub and/or a home of the user of the vehicle and/or a changeover destination that, for instance, affords an opportunity to change to another vehicle and/or to use another mobility service.

Preferably, however, the destination is not (substantially) altered. As such, for example, the destination can preferably be altered with regard to the original destination only within a (predefined and/or predefinable) radius of 5 km, preferably 1 km, preferably 500 m, preferably 200 m, preferably 100 m and particularly preferably 25 m. This provides for the advantage that, compared with the prior art, an emergency stop is not performed, but rather a compensation function for which performance of the arising vehicle function (still) remains achievable—albeit possibly while accepting for instance an increased travelling time, selection of another trajectory or the like—is determined.

Preferably, the (in particular central) computing device determines at least one control variable for executing the at least one (and preferably any) compensation function. Preferably, the (in particular central) computing device provides the determined at least one control variable to a control device of the vehicle for performing the compensation function, in particular for controlling actuators and/or motors and the like that are intended for performing the compensation function.

Preferably, the (in particular central) computing device determines at least one compensation variable that is characteristic of the (determinable and/or determined) compensation function, for example a compensation trajectory and/or a modified substitute destination for a driving task. Preferably, the compensation variable is determined on the basis of the at least one determined performance variable and/or error type.

Preferably, the (entire) computing device serves both as a central processing unit (in particular of a self-driving system) and as an (integrated) backup computer for the central processing unit.

Preferably, besides the (entire) computing device (having a multiplicity of computing units), the vehicle has no other computing unit that is suitable and intended as backup for the data processing operations on the sensor data and/or determination of the at least one control variable that are able to be performed by the computing device for, at least partially automatically and preferably fully automatically, executing the vehicle function, in particular driving function, of the vehicle.

In other words, besides the computing device, the vehicle preferably contains no other computing unit that is suitable and intended for data processing of sensor data determined by means of a multiplicity of sensor devices of the vehicle and/or that is suitable for taking the sensor data as a basis for determining the at least one control variable for, at least partially automatically and preferably fully automatically, executing the vehicle function, in particular driving function, of the vehicle.

Preferably, the overall functional capability of the computing device is chosen such that it exceeds the maximum functional capability of the computing device that is required in order to perform all of the vehicle function tasks to be performed by the computing device (in a normal mode, in particular predefined by an OEM) that arise in a predefined ODD (acronym for Operational Design Domain) by more than 20%, preferably by (in particular at least) 25% and particularly preferably by (at least) 30%.

Preferably, the overall functional capability of the computing device is chosen such that it exceeds the maximum functional capability of the computing device that is required in order to perform all of the vehicle function tasks to be performed by the computing device (in a normal mode, in particular predefined by an OEM) that arise in a predefined ODD (Operational Design Domain) by no more than 70%, preferably by no more than 50%, preferably by no more than 40% and particularly preferably by no more than 30%.

This affords the advantage that a high and uniform computer utilization level can normally be attained and furthermore no resource wastage is normally produced by a “concurrent backup”. This advantageously results in a cost saving, raw material saving and package advantages and the like.

In the event of an error (in particular if diminished performance of the computing device is detected), the proposed method advantageously results in a significantly extended ODD (Operational Design Domain), that is to say a significantly greater navigable space and/or driving profile and the like, compared with a conventional “mini backup” from the prior art.

In other words, an important concept of the invention in this context is the development of a combined main and backup computer unit. This unit may be implemented either in one device or in multiple devices connected with high bandwidth (preferably at least 5 Gbits/s, particularly preferably at least 8 Gbit/s and particularly preferably at least 10 Gbits/s). To explain the manner of operation, both normal operation and the case of error are considered in a preferred embodiment below.

### Normal Operation:

All in all the combined computing unit (computing device) preferably has enough computing power available to freely carry out all driving tasks that arise in a specific ODD (Operational Design Domain).

Preferably, the main and backup computers are in essence not identifiable as such, but rather process all arising (vehicle) tasks in combination (e.g. sensor data evaluation, trajectory computation, specification of vehicle direction control). The utilization level of the components is high and evenly distributed. Resources are not wasted.

### Error:

Any error types (failure of electronic components, failure of sensors/loss of sensor signals, partial failure of interface to vehicle) are considered by the combined computing unit (in particular by the computing device) such that the respective complementary hardware can continue to ensure a safe driving state.

In contrast to conventional backup concepts (prior art), although a restricted scope of functions is available, it advantageously significantly goes beyond that of a pure backup computer.

It is conceivable for example for the ODD to be restricted such that the entire “network” can continue to be used in consideration of new maximum speeds.

It is likewise conceivable for the use of roads having frequently complex driving situations (high speed on freeways, or multilane downtown junctions) to be avoided, but for travel within easily controllable ODDs (e.g. return to the service hub) to be possible in all cases.

In a preferred method, the error type is selected from a group of error types that includes a failure and/or restriction of an electronic component, a failure of at least one sensor device, a loss of sensor signals of at least one sensor device, a restriction and/or failure of a computing unit, a failure of an interface to the vehicle and the like and combinations thereof. This affords the advantage that a different compensation function can be determined on the basis of the determined error type

In a more preferred method, during normal operation, that is to say in particular when the functional capability of the computing device is undiminished, a utilization level of all of the components of the computing device, in particular the computing units, is and/or becomes substantially evenly distributed. This affords the advantage that the available resources are used uniformly in a normal mode. In particular, the available functional capability of the entire computing device can be used. Utilization of the computing resources of all of the computing units advantageously allows the entire functional capability of the computing units that is available in the vehicle to be designed to be smaller, allowing resources to be saved.

In a more preferred method, if a manifesting diminished performance of a computing unit of the computing device is detected, the data streams are reconfigured for a remaining computing unit, the functional capability of which is preferably not or at least not completely diminished. In particular, a failure of an interface of one computing unit to the vehicle can result in reconfiguration being carried out for a different computing unit of the computing device having an operational interface to the vehicle.

In a more preferred method, at least one predefined application limit (ODD, abbreviation for Operational Design Domain) for a permissibility of at least partially automatic and preferably fully automatic execution of a compensation function and/or a vehicle function is altered or adapted on the basis of the performance variable and/or the error variable. This advantageously defines the scope in which a vehicle function or the compensation function thereof is still executable.

The application limit may be predefined environmental conditions (weather), road conditions, conditions in the surroundings (level of the volume of traffic, type of road (fast road, rural road, downtown traffic, traffic-calmed region), (in particular user-specific) driving mode or driving profile, maximum speed, road types selected for performing the driving functions, and the like.

As such, it is possible to define for example whether a comfort driving mode (for instance selected on a user-specific basis) can still be provided or is still implementable. Such a comfort driving mode usually involves spring stiffnesses that are adjustable on the chassis being determined (by the computing device) before a forecast driving situation (for instance a sharp curve) is reached, in order to facilitate the most comfortable driving experience possible for the user. Such a forecast requires the detection of a driving situation that will arise in the future and determination of a reaction of the vehicle to lessen forces created thereby that affect the user of the vehicle.

Changing the application limits such that a driving mode such as this is no longer provided allows computation capacity to be saved and therefore a diminished performance of the computing device to be lessened or compensated for.

In a more preferred method, the compensation function comprises operation of the vehicle with a reduced sampling rate for at least one sensor device and preferably multiple sensor devices. It is conceivable, by way of example, for the sampling rate to be reduced by at least one third and preferably by (at least or substantially) half compared with a normal mode. This affords the advantage that the computation complexity for evaluating and processing the sensor data is considerably reduced. For example, the sampling rate can be reduced (preferably from a sampling rate of 20 Hz) to a sampling rate of no more than 10 Hz and particularly preferably no more than 5 Hz.

The sensor device that is operated and/or evaluated at a reduced sampling rate may be a sensor device for acquiring spatially resolved sensor data (in particular surroundings data), preferably a (front) camera and/or rear camera and/or a LIDAR and/or RADAR sensor. Particularly when acquiring spatially resolved sensor data, evaluation or processing thereof requires a comparatively high level of computing resources. A reduction in the sampling rate thereof can therefore result in the computer utilization level being significantly reduced.

In a more preferred method, the compensation function comprises operation of the vehicle with a reduced maximum speed for the vehicle. Preferably, this requires smaller volumes of data to be processed, since lower maximum speeds require less far (active) projection to be provided.

In addition, reduced maximum speed advantageously requires a lower sampling rate for the sensor device(s) (in particular in order to detect the vehicle surroundings). This also allows the required computing power to be reduced and therefore the diminished performance to be compensated for at least in part.

By way of example, it is conceivable for the maximum speed to be reduced to 100 km/h, preferably to 80 km/h and particularly preferably to 60 km/h. The maximum speed is preferably reduced on the basis of the (determined) performance variable.

Preferably, the sensor device (of the vehicle) is selected from a group of sensors that includes a (color) camera, a front camera, a rear camera, an infrared camera, LIDAR (abbreviation for Light Detection and Ranging, or Light Imaging, Detection and Ranging), radar, ultrasonic sensors and the like and combinations thereof. Preferably, the sensor device generates spatially resolved (in particular 2D and/or 3D) sensor data (from vehicle surroundings of the vehicle) in order to detect vehicle surroundings.

In a more preferred method, the compensation function comprises operation of the vehicle with at least one restricted sensor device. It is conceivable, for example, for the number of sensor devices used for executing the compensation function to be reduced. For example, instead of using a front camera and a LIDAR sensor (to detect the vehicle surroundings), it would be possible to use just the front camera. In addition, exclusively camera—and/or ultrasound-based sensor devices and in particular no laser-based sensor devices could be used to detect the vehicle surroundings.

The vehicle may have an at least indirect and preferably direct communication connection to at least one other vehicle and/or an infrastructure device (e.g. using car2car communication, C2C communication and/or Car2x communication and/or Car2I communication).

The vehicle can use the communication connection to receive at least one traffic situation variable that is characteristic of performance of the vehicle function task from at least one other vehicle or an infrastructure device at least indirectly (via other road users or infrastructure) and preferably directly.

The traffic situation variable may be characteristic of a level of a volume of traffic along an intended trajectory of the vehicle. It is conceivable for the traffic situation variable to be, for example, queue data and/or traffic data relating to a local (downtown) region, in particular along the intended (compensation) trajectory.

It is also conceivable for the traffic situation variable to indicate whether pedestrians can be expected along at least one section of the (compensation) trajectory. It is conceivable for a different trajectory to be selected if the presence of pedestrians can be expected, since traffic situations involving pedestrians, who may be at least partially concealed by other objects (for instance children between parked cars), in particular in busy and/or downtown regions, are usually comparatively computationally intensive (in particular to ensure a high level of safety).

Preferably, the compensation function can be determined and/or at least one application limit can be defined on the basis of the received characteristic traffic situation variable.

Preferably, the compensation function can be determined on the basis of historical (driving) data stored in a memory device of the vehicle and/or on the basis of swarm data (relating to a multiplicity of different vehicles). In this case, for instance the historical (driving) data and/or swarm data can be taken as a basis for determining what functional capability is required (statistically and/or on average and/or usually and/or on the basis of a predefined time of day), in particular at least and/or at most, in order to perform a predefined vehicle function. This makes it possible to assess whether the vehicle function that has arisen is still able to be performed or what compensation functions would be (substitutively) able to be performed.

Preferably, the vehicle function is a function of a vehicle component of the vehicle. Preferably, the vehicle component is selected from a group that includes a vehicle safety system (for example a braking system), a system for guiding the vehicle, an in particular automatic vehicle lateral control system, a lane departure warning system, a lane-change assist system, a navigation system, a locking system for a vehicle door and/or a vehicle window, a windshield wiper mechanism, a vehicle locking system, an infotainment system, an entertainment system and/or a comfort system to increase the driving comfort of an occupant and combinations thereof.

The present invention is furthermore directed to a compensating apparatus for a vehicle for compensating for a manifesting diminished performance of a, in particular central, computing device of a vehicle, which computing device can be used to at least partially automatically and preferably fully automatically execute an arising vehicle function for performing a vehicle function task.

The, in particular central, computing device comprises at least one computing unit and preferably a multiplicity of computing units. Preferably, the computing unit, and particularly preferably, the multiplicity of computing units, may be (single or multiple) physical control units, (single or multiple) physical chips within a control unit or single processors or chiplets within a chip.

The, in particular central, computing device is suitable and intended for data processing of sensor data determined by means of a multiplicity of sensor devices of the vehicle. Furthermore, the, in particular central, computing device is suitable and intended for taking the sensor data as a basis for determining at least one control variable for, at least partially automatically and preferably fully automatically, executing the vehicle function, in particular driving function, of the vehicle.

The vehicle has a monitoring unit for monitoring a functional capability of the computing device in order to determine a manifesting diminished performance of the computing device, which monitoring unit is suitable and intended for, in the event of a manifesting diminished performance, determining at least one performance variable that is characteristic of a still available functional capability of the computing device and at least one error variable that is characteristic of an error type relating to the diminished performance of the computing device.

According to the invention, the compensating apparatus is suitable and intended for, if performance of the vehicle function task is at risk, determining at least one compensation function for substitutive execution instead of the vehicle function on the basis of the at least one determined performance variable and/or the at least one error variable and on the basis of the vehicle function task that is to be performed.

In other words, the computing device determines a compensation function that the vehicle is supposed to execute instead of the vehicle function. The compensation function is preferably chosen such that performance of the (original) vehicle function task is facilitated—at least in part and preferably in full—by the compensation function.

Thus, it is also proposed, within the context of the compensating apparatus according to the invention, that the, in particular central, computing device provided be a combined main and backup computer unit that can be implemented either in one device or in multiple devices connected with high bandwidth (for the purpose of data interchange).

Preferably, the compensating device is configured, suitable and/or intended for carrying out the method described above and all of the method steps already described above in connection with the method individually or in combination with one another. Conversely, the method may be equipped with all of the features described within the context of the compensating apparatus individually or in combination with one another.

The present invention is furthermore directed to a vehicle, in particular a motor vehicle, comprising a compensating apparatus for a vehicle in accordance with one embodiment as described above. The vehicle may be in particular a (motorized) road vehicle.

A vehicle may be a motor vehicle that is in particular a motor vehicle controlled by the driver themself (“driver only”), a semiautonomous, autonomous (for example on autonomy level 3 or 4 5 (from the SAE J3016 standard)) or self-driving motor vehicle. Autonomy level 5 denotes fully automatically driving vehicles. Similarly, the vehicle may be a driverless transport system. The vehicle may be controlled by a driver or may drive autonomously. In addition, the vehicle may be not only a road vehicle but also an air taxi, an aircraft and another means of transport or another vehicle type, for example an aircraft, watercraft or rail vehicle.

The present invention is furthermore directed to a computer program or computer program product, comprising program means, in particular a program code, that represents or encodes at least some and preferably all of the method steps of the method according to the invention and preferably one of the preferred embodiments described and is designed to be executed by a processor device.

The present invention is furthermore directed to a data memory that stores at least one embodiment of the computer program according to the invention or of a preferred embodiment of the computer program.

Other features which are considered as characteristic for the invention are set forth in the appended claims.

Although the invention is illustrated and described herein as embodied in a method and a compensating apparatus for a vehicle for compensating for a manifesting diminished performance of a computing device of a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic representation of a vehicle having a computing device and a compensating apparatus according to a preferred embodiment of the invention;

FIG. 2 shows a representation of combined computing units of a computing device according to a preferred embodiment;

FIG. 3 shows an illustration of the procedure of the method according to the invention according to a preferred embodiment; and

FIG. 4 is a flowchart for a method according to a preferred embodiment of the invention.

### DETAILED DESCRIPTION OF THE INVENTION

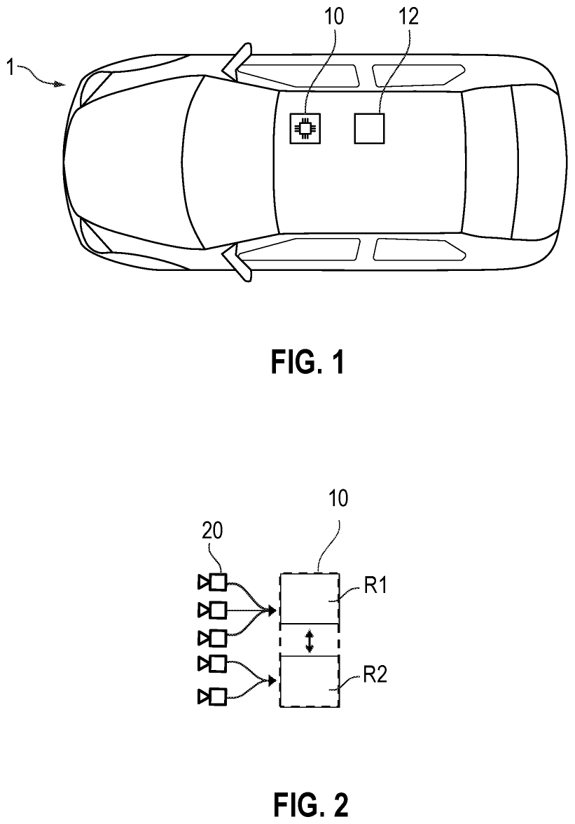

FIG. 1 shows a schematic (overview) representation of a vehicle 1 having a computing device 10, here a central computer 10, according to the invention and a compensating apparatus 12 for the vehicle 1.

FIG. 2 shows a representation of combined computing units R1, R2 (of a, in particular central, computing device 10) with high bandwidth for connection. The units R1 and R2 may be installed either individually or separately. Connected sensors or sensor devices 20 (and at the same time also analogous vehicle interfaces) each facilitate continued use in restricted ODDs.

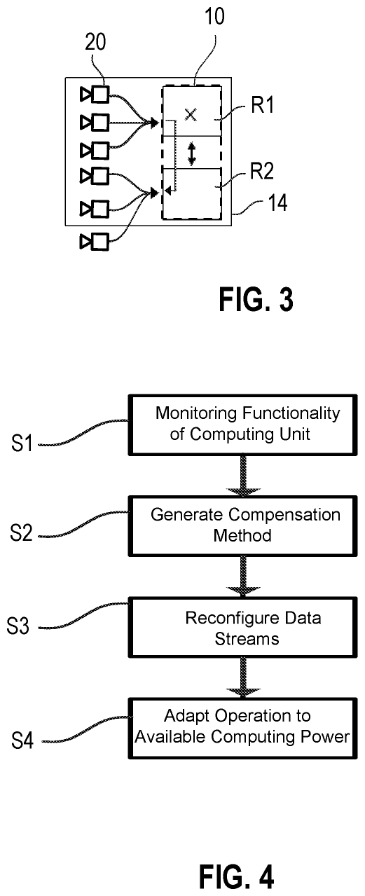

FIG. 3 uses a case example (computing unit error diagnosis) to show in more detail the procedure on which one embodiment of the method according to the invention is based.

As can be seen from FIG. 3, specific chips held (which already provide necessary monitoring functions as standard) can be used to detect a failure or diminished performance of at least one computing unit within a chosen monitoring limit 14.

Accordingly, a compensation method appropriate to the error is selected and implemented (e.g. by reconfiguring data streams of individual sensors).

If necessary (and this can be assumed), the ODD (Operational Design Domain, an expression of application limits within which execution of an at least partially automatic and preferably fully automatic vehicle function is permissible), that is to say in particular navigable spaces, driving profile, etc., is adapted. By way of illustration, reduction of the maximum speed caused by lower sampling rates of the sensors will be mentioned.

The computing units may be
a. single (multiple) physical control units
b. single (multiple) physical chips within a control unit
c. single processors and/or chiplets within a chip

FIG. 4 shows a flowchart for a method according to the invention according to a preferred embodiment, comprising the following method steps:

Preferably, the functional capability of a computing device 10 and/or of a computing unit R1, R2 is monitored (in particular by a monitoring unit 12), particularly preferably continuously.

In particular the monitoring may result in detection of a failure/diminished performance of the computing unit R1 (as illustrated by the cross symbol in FIG. 3). Such detection is denoted by the reference sign S1 in FIG. 4. The second computing unit R2 is preferably fully functional.

In a subsequent method step S2, a compensation method is designed, preferably by the monitoring unit 12.

In another, preferably subsequent, method step S3, the data streams are preferably reconfigured for the remaining computing unit R2 (preferably by the monitoring unit 12).

In another, preferably subsequent, method step S4, the ODD (Operational Design Domain) is adapted according to the integrally available computing power (for instance on the basis of the determined performance variable). For example, this can be accomplished by way of a lower sampling rate. If a lower sampling rate is chosen, this preferably implies a lower maximum speed (of the vehicle).

The applicant reserves the right to claim all of the features disclosed in the application documents as essential to the invention, provided that they are novel over the prior art individually or in combination. Furthermore, it is pointed out that the individual figures have also been used to describe features that may be advantageous in themselves. Those of skill in the pertinent art will recognize that a specific feature described in a figure may be advantageous even without adopting other features from this figure. Further, a person skilled in the art will recognize that advantages may also arise as a result of a combination of multiple features shown in individual or in different figures.

The following is a summary list of reference numerals and the corresponding structure used in the above description of the invention:
1 vehicle
10 computing device
12 monitoring unit
14 monitoring limit
20 sensor device
R1, R2 computing unit
S1-S4 method steps

1. A method for compensating for a diminished performance of a computing device of a vehicle, wherein the computing device is used to automatically execute a vehicle function for performing a vehicle function task and the computing device includes at least one computing unit and is configured for data processing of sensor data acquired by a multiplicity of sensor devices of the vehicle and for taking the sensor data as a basis for determining at least one control variable for executing the vehicle function, the method comprising:
monitoring a functional capability of the computing device in order to detect a manifesting diminished performance of the computing device and, when a manifesting diminished performance is detected, determining at least one performance variable that is characteristic of a still-available functional capability of the computing device and determining at least one error variable that is characteristic of an error type relating to the diminished performance of the computing device;
when a performance of the vehicle function task is at risk, determining at least one compensation function for substitutive execution instead of the vehicle function on a basis of the at least one determined performance variable and/or the at least one error variable and on a basis of the vehicle function task to be performed.

2. The method according to claim 1, wherein the computing device is a central computing device of the vehicle configured to fully automatically or partially automatically execute the arising vehicle function.

3. The method according to claim 1, wherein the at least one computing unit is a plurality of computing units.

4. The method according to claim 1, wherein the vehicle function is a driving function.

5. The method according to claim 1, wherein the error type is an error type selected from the group consisting of a failure or restriction of an electronic component, a failure of at least one sensor device, a loss of sensor signals of at least one sensor device, a restriction or failure of a computing unit, a failure of an interface to the vehicle, and combinations thereof.

6. The method according to claim 1, wherein during normal operation, when the functional capability of the computing device is undiminished, a utilization level of all of the components of the computing device is substantially evenly distributed.

7. The method according to claim 6, wherein during normal operation, the utilization level of the computing units remains evenly distributed.

8. The method according to claim 1, which comprises, when a manifesting diminished performance of a computing unit of the computing device is detected, reconfiguring the data streams for a remaining computing unit.

9. The method according to claim 1, which comprises altering at least one predefined application limit for a permissibility of an execution of a compensation function and/or a vehicle function based on the performance variable and/or the error variable.

10. The method according to claim 1, wherein the compensation function comprises setting an operation of the vehicle with a reduced sampling rate for at least one sensor device.

11. The method according to claim 1, wherein the compensation function comprises setting an operation of the vehicle with a reduced maximum speed for the vehicle.

12. A compensating apparatus for a vehicle for compensating for a manifesting diminished performance of a computing device of the vehicle that is used to execute an arising vehicle function for performing a vehicle function task;
the computing device having at least one computing unit and being configured for data processing of sensor data acquired by a multiplicity of sensor devices of the vehicle and for taking the sensor data as a basis for determining at least one control variable for executing the vehicle function;
the vehicle having a monitoring unit for monitoring a functional capability of the computing device in order to detect a manifesting diminished performance of the computing device, the monitoring unit being configured, on occasion of a manifesting diminished performance, to determine at least one performance variable that is characteristic of a still-available functional capability of the computing device and at least one error variable that is characteristic of an error type relating to the diminished performance of the computing device,
the compensating apparatus being configured, when the performance of the vehicle function task is at risk, to determine at least one compensation function for substitutive execution instead of the vehicle function on a basis of the at least one determined performance variable and/or the at least one error variable and on a basis of the vehicle function task to be performed.

13. The compensating apparatus according to claim 12, wherein the computing device is a central computing device of the vehicle configured to fully automatically or partially automatically execute the arising vehicle function.

14. The compensating apparatus according to claim 12, wherein the at least one computing unit is a plurality of computing units.

15. The compensating apparatus according to claim 12, wherein the vehicle function is a driving function.

16. The compensating apparatus according to claim 12, wherein the computing unit is at least one component selected from the group consisting of a physical control unit of the vehicle, at least one physical chip within a control unit of the vehicle, at least one processor, and a chiplet within a chip of the vehicle.

17. A vehicle, comprising a compensating apparatus according to claim 12.

18. The vehicle according to claim 17, being a motor vehicle.
